(19) United States
(12) Patent Application Publication
(10) Pub. No.: US 2019/0380298 A1
(43) Pub. Date: Dec. 19, 2019

(54) FLOOR CONSTRUCTION ELEMENT

(71) Applicant: Gerhard Grabner, Neustift-Innermanzing (AT)

(72) Inventor: Gerhard Grabner, Neustift-Innermanzing (AT)

(21) Appl. No.: 16/463,752

(22) PCT Filed: Nov. 23, 2017
(86) PCT No.: PCT/EP2017/080265

§ 371 Date: May 23, 2019

(30) Foreign Application Priority Data
Nov. 23, 2016 (AT) A 530/2016
Mar. 10, 2017 (AT) PCT/AT2017/060061

(51) Int. Cl. A01K 1/015; A01K 1/01

(52) U.S. Cl. CPC A01K 1/0151; A01K 1/0094; A01K 1/01

(57) ABSTRACT

Floor construction element for a horse stable with a cover surface element (6) and a support device for support against a floor (1), wherein the cover surface element (6) has a variety of passage openings (5, 50) and by the supporting device between the floor (1) and the cover surface element (6) at least one drainage cavity (4) is formed by way of which liquid excretions of the horse can be drained out, wherein the passage openings (5, 50) are arranged in an evenly distributed manner over the cover surface element, wherein bridges (110) run for supporting or stiffening between the passage openings (5, 50), and wherein the passage openings (50) are each defined by an arrangement of a number of screen openings (71) which are formed in the cover surface element (6), or a screen element (7) with a plurality of screen openings (70) is inserted in the passage openings, wherein the screen openings (70, 71) are permeable to the liquid excretions, but prevent the entry of relatively large, solid particles into at least one drainage cavity (4) and the clogging of the passage openings (5, 50), whereby the diameter or opening width (k) of the screen openings (70, 71) is much smaller than the diameter D or the opening width of the passage openings (5, 50) and the thickness (C) of the screen element (7) or the depth of the screen openings (70, 71) is much smaller than the diameter D or the opening width of the passage openings (5, 50).

The invention relates to a floor construction element for a horse stable with a cover surface element and a support device for supporting against a floor, wherein the cover surface element has a number of passage openings and at least one drainage cavity is formed by the supporting device between the floor and the cover surface element, by way of which liquid excretions of the horse can be carried out.

The keeping of horses differs fundamentally from that of other stable animals, since horses need more clearance and a soft ground because of their lying behavior and their greater feed and movement requirements, and they should stay in an environment that is as dust-free and ammonia-free as possible.

In the context of this disclosure, horse stables are understood to mean, in particular, stables with stalls, free-range stables, horse trailers and horse transporters.

Too hard a soil presents a major impairment to the well-being of horses and involves a high, serious risk of injury due to stress on the joints, tendons, bones and hooves.

Furthermore, horses are also very sensitive to pollution of their environment by fecal matter, which is why a bedding layer is provided in conventional stables, which provides a soft, absorbent surface and helps prevent the horse from becoming injured or a larger amount of fluid accumulating on the ground.

The disadvantage of this bedding layer is mixing the same with horse dung or horse urine, such that after a short time, a complete replacement of the bedding must be performed to prevent a hygienic impairment of the horse. The horse excretions, which are in themselves very valuable for fertilization purposes, can only be utilized to a limited extent due to the mixing of horse urine and horse droppings with litter, especially if the latter contains, for example, wood shavings or sawdust.

In addition to the feeling of wetness and the risk of slipping for the horse, the horse urine collected in the bedding causes a high concentration of ammonia gas in the stable air, which can be an odor nuisance and health hazard to humans and horses.

The disadvantages, therefore, are the high bedding consumption, the required working time, the accrual of a high volume of manure and the cost of disposal of the same.

From DE 100 27 480, a floor for horse stables is apparent, the elements of which have parallel joints, which are connected on the underside with common collector pipes, which in turn are connected to a flushing device. The disadvantage of this device is the relatively fast clogging of the joints with dust, horse manure, horse hair, dirt and pebbles from outside, which the horses carry into the stall, and by swelling of the litter. The joints must then undergo laborious cleaning.

In WO 94/02003, an elastic floor mat is provided, which is a replacement of the conventional straw or bedding bed, with holes in the mat and an underlying drainage system which ensures that the liquid excretions can be carried away. In this document, however, it is not described how the solid horse excrement, dust, hair, other dirt, pebbles, etc. are prevented from causing closure of the drainage holes or may result in slipping of the horses.

JP 08317741 A describes a urine drainage device in which a rubber-coated plate is used as a damping level having holes for draining the urine into an underlying channel device at specific locations, but no means are provided for preventing the closure of the holes with solid components. In addition, there are areas of the damping level which have no holes, which leads to a collection of liquid and the resulting wetting of the bedding. As can be seen from FIG. 4 of this document, the drainage devices described there are embedded side by side in concrete, so that between these a relatively large distance is created, which is covered only by concrete mass, so that no urine drainage takes place in this area.

Overall, all previous attempts to find a satisfactory form of horse urine drainage have failed, because within a very short period of time, the holes provided for the drainage must be relocated and a cleaning of the same is possible only with great effort.

The object of the invention is therefore to provide a floor construction element for a horse stable which achieves a strong improvement of the above-described conditions and faster cleaning of the stable, a lower manure volume and a significant improvement in hygienic conditions and a reduction in the ammonia concentration and aspects which are hazardous to health.

Another object is to provide a floor construction element as explained above, the passages of which into the drainage cavity can be easily cleaned.

According to the invention, this is achieved in that the passage openings are arranged in an evenly distributed manner over the cover surface element, wherein bridges for supporting or stiffening run between the passage openings, and that the passage openings are each defined by an arrangement of several screen openings, which are formed in the cover surface element or in the passage openings, a screen element is used with a number of screen openings, wherein the screen openings are permeable to the liquid excretions, but prevent the entry of relatively large, solid particles into the at least one drainage cavity and the clogging of the passage openings, wherein the diameter or the opening width (k) of the screen openings is much smaller than the diameter D or the opening width of the passage openings, and the thickness (C) of the screen element or the depth (t) of the screen openings is much smaller than the diameter D or the opening width of the passage openings.

A variety of identical cover surface elements can be combined to form a continuous surface within a horse stable which is spaced from the ground.

The cover surface element provides a support for the bedding layer and, through the spacing from the floor, creates the drainage cavity into which the excretions can be drained. Thus, the top surface element is liquid-permeable and thus ensures a rapid dissipation of the liquid excretions from the stalled horse during the urination process, which consist mainly of horse urine, into the cavity formed below the top surface element. In this way, the bedding layer essentially comes into contact with liquid only to the extent of the stream diameter and, in contrast to previously used bedding material, the latter is preferably only very slightly absorbent and therefore only of little suitability for receiving liquid. As a result, there is no significant liquid storage within the bedding layer, which may consist of wood granules, for example, whereby this retains its protective function for the horse and can be left for a long time within the horse stable. Accordingly, the overall result is a lower ammonia load and a saving of bedding and manure to be discharged. The cleaning of a stable constructed according to the invention is thereby considerably easier, and the resulting waste products can be further processed with a very high level of purity.

The passage openings uniformly distributed over the cover surface element should have such a large diameter or opening width that they represent the lowest possible flow resistance to the draining horse urine. The upper limit for the diameter or the opening width of the passage openings is to be regarded as the opening width at which, for reasons of safety for the horse, penetration of the horse's hoof into the passage opening is still prevented. At the same time, sufficient material of the top surface element must remain between each adjacent passage openings, in order to ensure sufficient mechanical stability and to be able to bear the weight of a horse.

By providing screen openings in the passage openings in the region of the upper side of the damping level, the penetration of solid particles, for example, bedding particles from the bedding layer is prevented, and at the same time the liquid excretions can be drained unhindered.

The screen openings according to the invention can be formed by screen elements inserted into the passage openings or the passage openings can be defined by arrangements of screen openings directly in the cover surface element, which are separated from one another by bridges in order to provide the necessary strength and support downwards.

As has been found, the screen openings are to be dimensioned so that the passage length of the screen openings is very small in order to avoid shifting of the screen openings due to deposits, which is achieved by the preferably flat screen element or the screen grid area of the screen element or the cover surface element with the screen openings formed therein having a very small thickness, so that a small passage length of the screen openings is provided, which prevents an accumulation of solid impurities and which allows easy cleaning of the screen elements. An air or water stream is sufficient, for example, to blow through the screen openings. Even if the horse is urinating and the urine hits the screen openings, the urine stream in this case also has a flushing effect.

The screen openings may, according to a further embodiment of the invention, open conically downwardly to prevent clogging of the same.

Due to the existing screen openings, the bedding is prevented from entering the passage openings as is the swelling of the bedding in the passage openings and rapid clogging of the same, since there is now no opening or hole where the bedding can collect and wetness, which necessarily arises during urination, swells the bedding and it thereby clogs the hole and obstructs the liquid flow.

A bedding change is actually almost no longer necessary in the floor construction element, according to the invention. The bedding is reprocessed only at intervals of about 1 month with a vibrating floor screen, by screening out certain small particles, such as horse manure, dust, horse hair and other dirt or pebbles which the horses carry with them into the stall. The bedding can then be used again at the highest level. In the course of this, the stall is then vacuumed out, for example, by means of a vacuum cleaner and freed from dust, and the screen openings are cleaned, if necessary, simply and quickly. A particularly hygienic state can also be achieved by washing the screen openings or the screen elements with water with a simple garden hose and washing them through from top to bottom. In clinics, cleaning can also be done very easily with disinfectants.

In a further embodiment of the invention, the passage openings may be arranged in a matrix shape in order to ensure the most dense and uniform distribution of the passage openings.

In a further embodiment of the invention, the passage openings may have a circular cross-section, but all other forms of cross-sections, for example quadrangular, square, pentagonal, hexagonal, oval, etc., are equally executable. The diameter or the opening width of the passage openings can also vary within the cover surface element, so that, for example, larger and, at the edge, smaller passage openings can be provided in the middle of the damping level.

The diameter of the passage openings can be selected in a range of 5 mm to 50 mm, but also smaller or larger passage openings can be used as required.

In order to also allow the use of materials with low strength and high elasticity for the top surface element, the top surface element may comprise a cover plate having a support at the bottom going the other way and/or stiffening ribs in order to avoid excessive deflection under load.

To protect the stalled horse and avoid injury, the cover plate may be formed, for example, of an elastic material, which causes a better damping of shocks. According to a further embodiment of the invention, a damping layer or a damping plate made of an elastic material may be attached to the top of the cover plate.

According to a further embodiment, the screen openings may be formed in the cover plate.

Furthermore, it can be provided that the screen element is formed by a hollow insert, which is fitted into the respective passage opening, and that the upper end of the hollow insert has a grid screen.

According to a further embodiment of the invention, the hollow inserts can be glued or cast into the passage openings of the cover plate.

Furthermore, the screen elements can be sleeve-shaped and can be inserted into the passage openings. In this way, they can be easily replaced if damaged, or easily cleaned. They may be, for example, but not only, made of plastic, e.g. injection-molded, or formed of metal.

Further, the screen elements may be permanently connected to the passage openings to prevent them from being able to move out of the passage openings.

The screen elements can also be integrated in the damping level, for example by being vulcanized into the latter.

Another embodiment of the invention may be that the upper end of the hollow insert comprises a grid screen.

The opening diameters of the grid screen can be chosen arbitrarily, for example in a range from 1 mm to 10 mm or larger, preferably from 1 mm to 5 mm, whereby the function of retaining solid particles and draining the liquid portions must remain fulfilled.

The grid screens may be slightly sloping at the surface where the ports are located, not only straight but also from the outer edge to the center, and thereby better drain the fluid.

An embodiment of the invention may consist in the screen element being hollow-cylindrical and having at its lower end a flange with which the screen element is seated in the inserted state on the underside of the cover surface element, wherein preferably the grid screen of the insert relative to the top of the cover surface element is offset downward, such that the horse cannot come into contact with the screen element.

In order to protect the screen elements from heavy loads by the horse, in a further embodiment of the invention, the screen element can exhibit in its interior at least one reinforcing bridge, which is preferably arranged diametrically and in a cross shape.

In the context of the invention, other types of reinforcement can also be provided by increasing the wall thickness of the screen element or the like.

According to one embodiment of the invention, the screen element may be formed from a thermoplastic elastomer from the group of TPE-V or an impact-resistant polypropylene copolymer, in particular injection-molded. This gives a sufficiently high elasticity, impact resistance and fatigue resistance.

However, the screen element may also be made of other suitable materials that are resistant to external mechanical impact.

By a small downward displacement of the screen elements relative to the cover surface element, there is a small distance to the top of the cover surface element, so that the screen elements are better protected from the mechanical effects of horse hooves and the horse in turn cannot come into contact with the screen elements in the lying state. However, also the displacement of the screen elements can be dispensed with, so that they are flush with the top of the cover surface element.

In a further embodiment of the invention, the cover surface element may comprise a supporting grid element and on the grid element a damping plate made of an elastic material may be mounted or arranged, wherein the passage openings are provided in the damping plate, for which passage openings are arranged in alignment with grid openings of the grid element, and the screen elements are embedded or glued into the passage openings of the damping plate.

In this way, a damping plate made of an elastic material may be provided above the supporting grid element, in order to allow the best possible protection of the stalled horse. The passage openings are arranged so that each lies above one of the grid openings of the grid element, in order to allow a rapid and resistance-free outflow of liquid horse excretions.

The cover surface element can be mounted in different ways, wherein a high mechanical stability and a simple structural design can be achieved in that the support device has two lateral support walls spaced by a bottom wall on which the cover surface element can be placed. In this way, a modular construction is ensured, which makes it possible that any number of cover surface elements can be strung together to cover the entire footprint of a horse stable.

In order to achieve the fastest possible drainage of the excretions, appropriate gradients and guides may be provided to selectively drain the excretory fluids, but at the same time provide support points inside the drainage cavity to support the cover surface elements spanning the drainage cavity appropriately, so that the weight of the horse acting from above does not cause excessive deflection of the top surface element.

In a further embodiment of the invention, it can therefore be provided that the bottom wall of the supporting device forms parallel grooves for draining the liquid excretions, and that supporting surfaces, which the inner support bridges of the cover plate lie on when the cover surface element is attached, are formed on the connecting lines of adjacent grooves.

In a modular construction, it is further necessary to provide a continuous discharge of the liquid excretions through several floor construction elements according to the invention, so that they can be led, for example, to a collection channel.

According to a further embodiment of the invention, therefore, the parallel grooves relative to the support walls may jut out at one end and be recessed at the opposite end, so that the projecting groove sections with the recessed groove sections of two adjacent floor construction elements are frontally engageable and can be sealingly connected by means of a sealing element.

In order to facilitate the juxtaposition of several floor construction elements according to the invention and to make it precise, without gap formation between adjacent elements, it can be provided that groove and spring elements are arranged on the outer sides of the mutually opposite support walls, so that two adjacent floor construction elements can be brought into engagement with one another on their support wall side.

According to a further variant of the invention, the bottom wall can be formed as an inclined plane and at the lowest point of the inclined plane a drainage hole and in the region of the highest point a drainage bore can be formed for connection to a flushing line to allow an advantageous flushing of the floor construction element according to the invention.

In order to better compensate for the different heights of the floor on an uneven ground, according to a further variant of the invention, a support frame for supporting the cover surface element can be formed through which flushing lines are routed, and is mounted on its underside by support feet relative to the ground, wherein the support frame exhibits recesses through which the liquid excretions which can be drained away.

The invention will be explained in detail below with reference to the embodiments shown in the accompanying drawings. In the following figures,

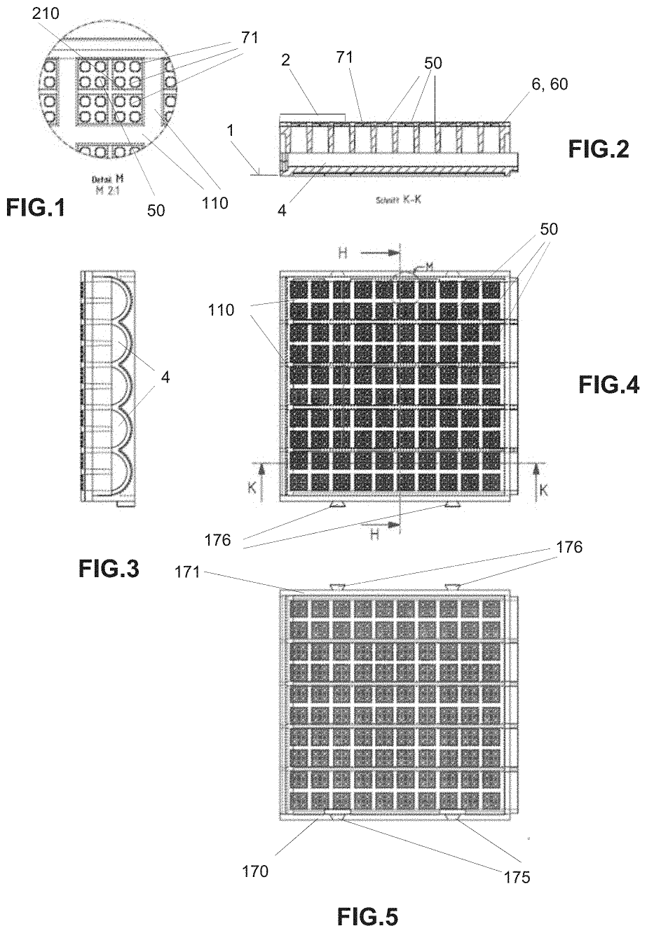

FIG. 1 shows a view from above of a detail of an embodiment of a floor construction element according to the invention;

FIG. 2 shows a section K-K of the embodiment of FIG. 1;

FIG. 3 shows a side view of the embodiment according to FIG. 1;

FIG. 4 shows a top view of the embodiment according to FIG. 1;

FIG. 5 is a view of the embodiment of FIG. 1 from below;

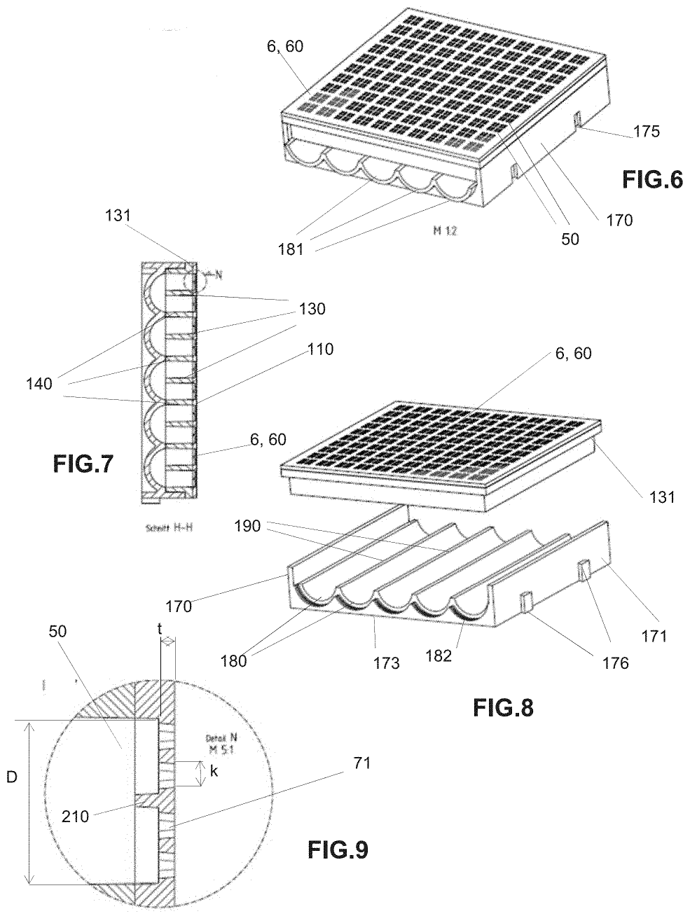

FIG. 6 is an oblique view of the embodiment of FIG. 1;

FIG. 7 shows a section H-H through the embodiment of FIG. 1;

FIG. 8 shows an exploded view of the embodiment according to FIG. 1;

FIG. 9 shows a detail of a section of the embodiment according to FIG. 1;

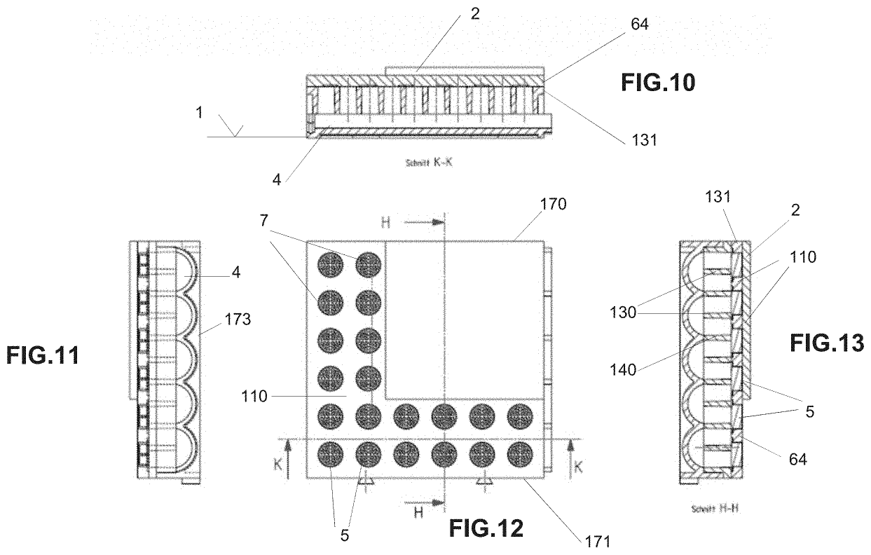

FIG. 10 shows a section K-K through a further embodiment of the floor construction element according to the invention;

FIG. 11 shows a side view of the embodiment according to FIG. 10;

FIG. 12 is a top view of the embodiment of FIG. 10;

FIG. 13 shows a section H-H of the embodiment according to FIG. 10;

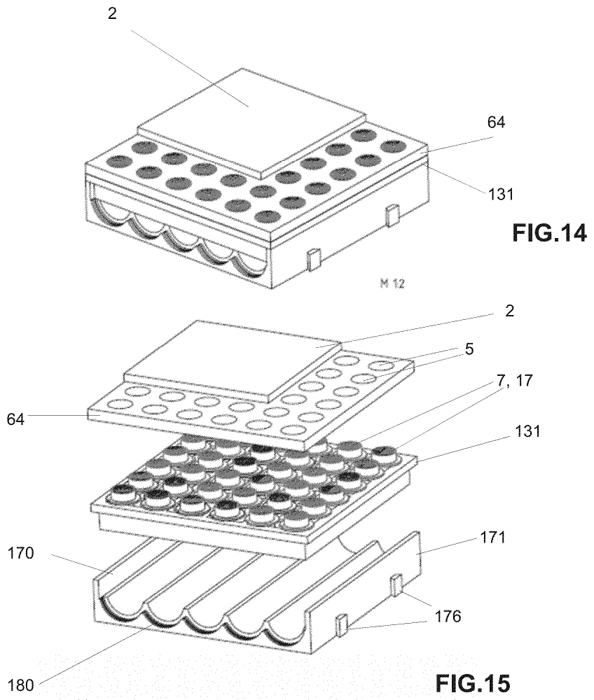

FIG. 14 shows an oblique view of the embodiment according to FIG. 10;

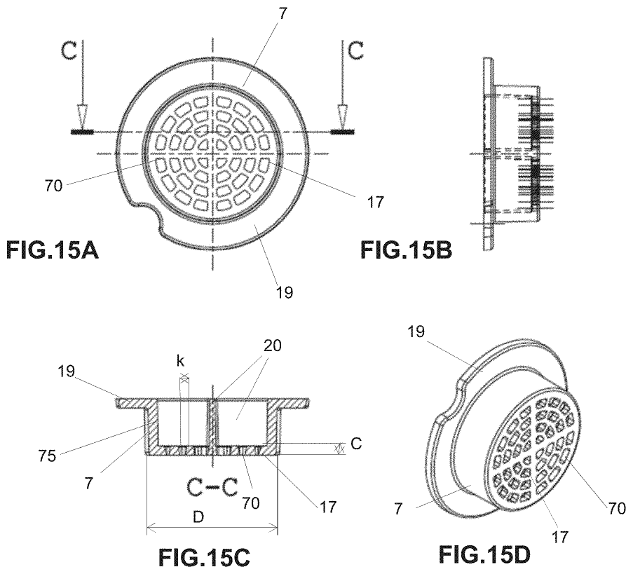

FIG. 15 is an exploded view of the embodiment of FIG. 10;

FIG. 15A is a partially cutaway oblique view of a detail of the embodiment of FIG. 10;

FIG. 15A to 15D is a top view, a side view, a section C-C and an oblique view of a screen element of the embodiment of FIG. 10 in magnification;

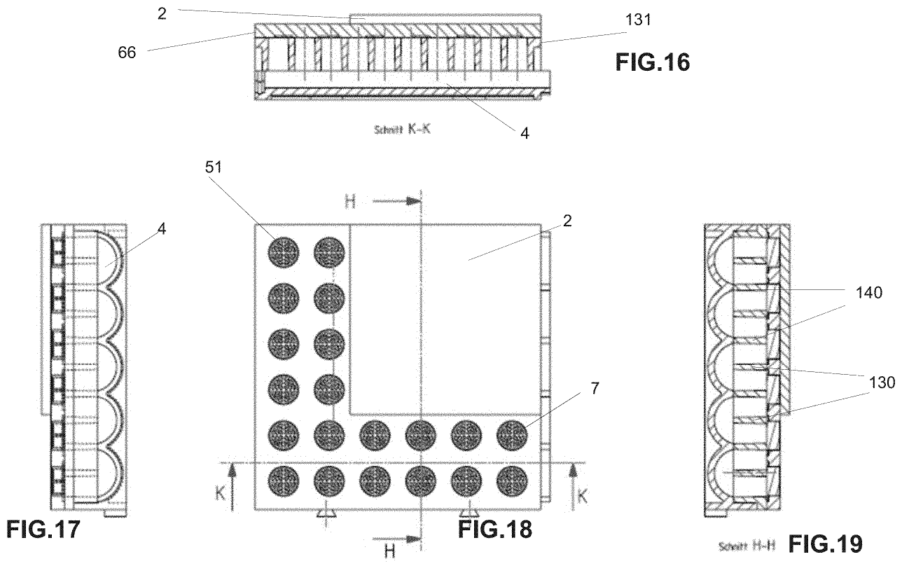

FIG. 16 shows a section K-K through a further embodiment of the floor construction element according to the invention;

FIG. 17 shows a side view of the embodiment according to FIG. 16;

FIG. 18 is a top view of the embodiment of FIG. 16;

FIG. 19 shows a section H-H through the embodiment according to FIG. 16:

FIG. 20 shows an oblique view of the embodiment according to FIG. 16;

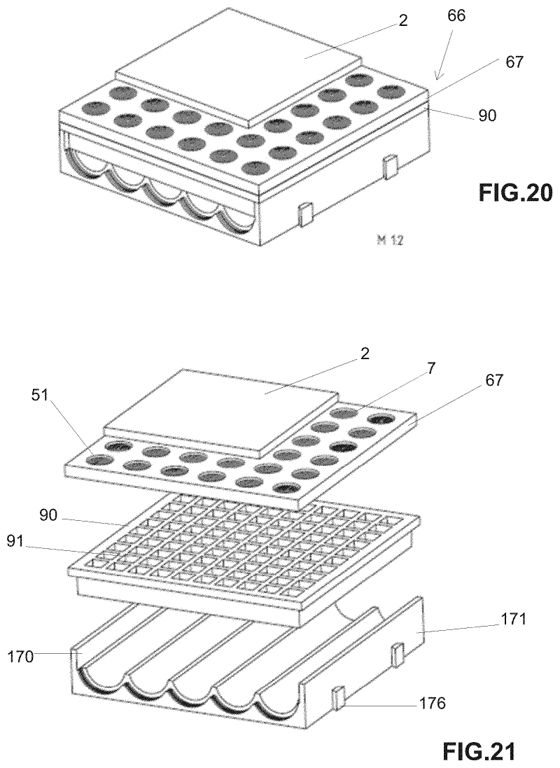

FIG. 21 is an exploded view of the embodiment of FIG. 16;

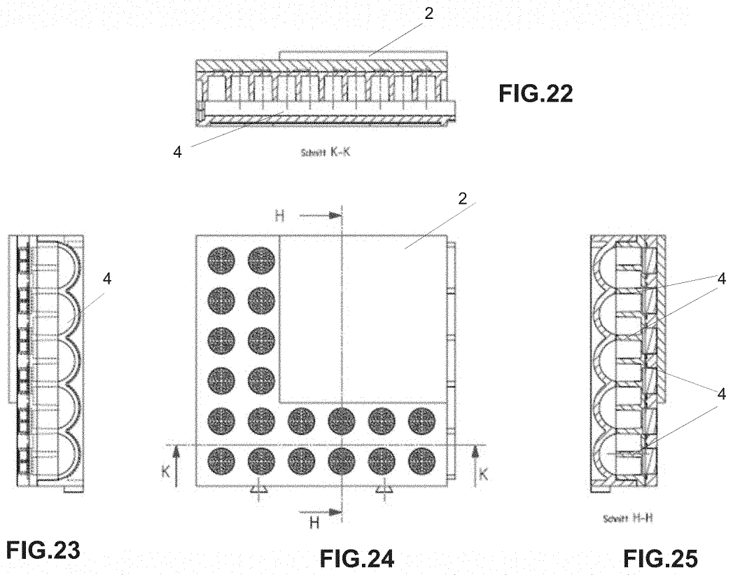

FIG. 22 shows a section K-K through a further embodiment of the floor construction element according to the invention;

FIG. 23 shows a side view of the embodiment according to FIG. 22;

FIG. 24 shows a top view of the embodiment according to FIG. 22;

FIG. 25 shows a section H-H through the embodiment according to FIG. 22:

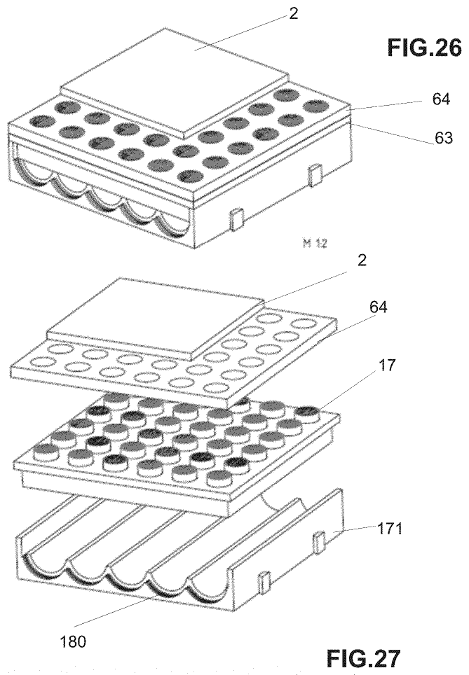

FIG. 26 is an oblique view of the embodiment of FIG. 22;

FIG. 27 is an exploded view of the embodiment of FIG. 22;

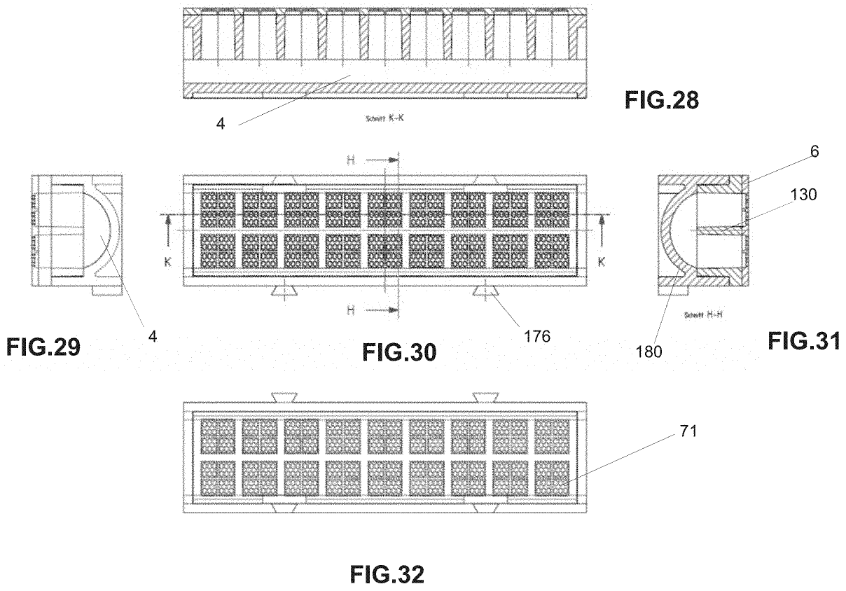

FIG. 28 shows a section K-K through a further embodiment of the floor construction element according to the invention;

FIG. 29 shows a side view of the embodiment according to FIG. 28;

FIG. 30 is a top view of the embodiment of FIG. 28;

FIG. 31 shows a section H-H through the embodiment according to FIG. 28:

FIG. 32 is a bottom view of the embodiment of FIG. 28;

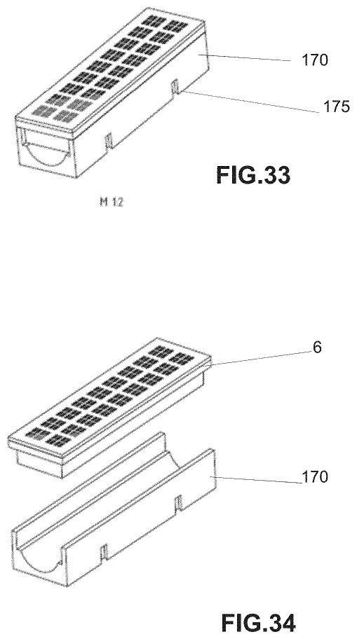

FIG. 33 shows an oblique view of the embodiment according to FIG. 28;

FIG. 34 is an exploded view of the embodiment of FIG. 28;

FIG. 35 shows a detail of a further embodiment of the floor construction element according to the invention;

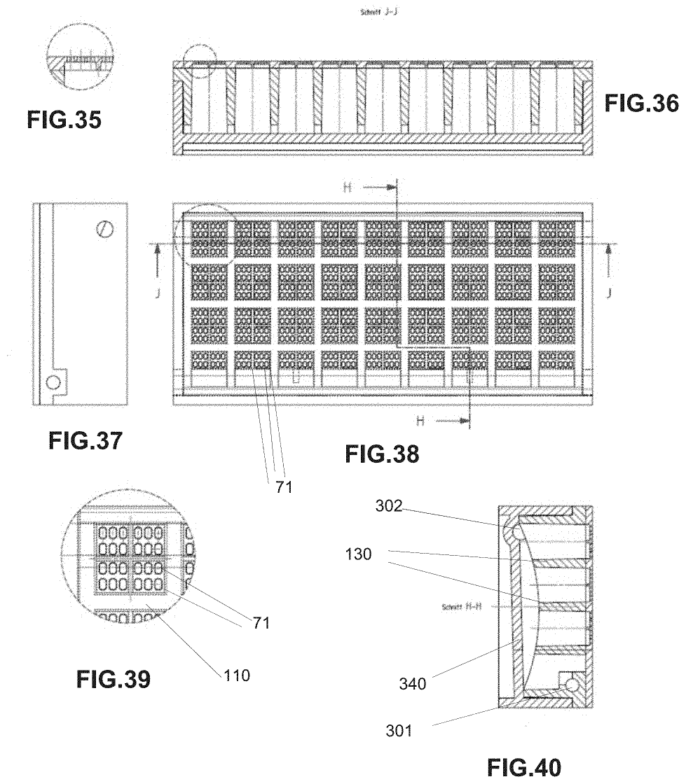

FIG. 36 shows a section J-J of the embodiment according to FIG. 35;

FIG. 37 shows a side view of the embodiment according to FIG. 35;

FIG. 38 is a top view of the embodiment of FIG. 35;

FIG. 39 shows a further detail of the embodiment according to FIG. 35;

FIG. 40 shows a section through the embodiment according to FIG. 35;

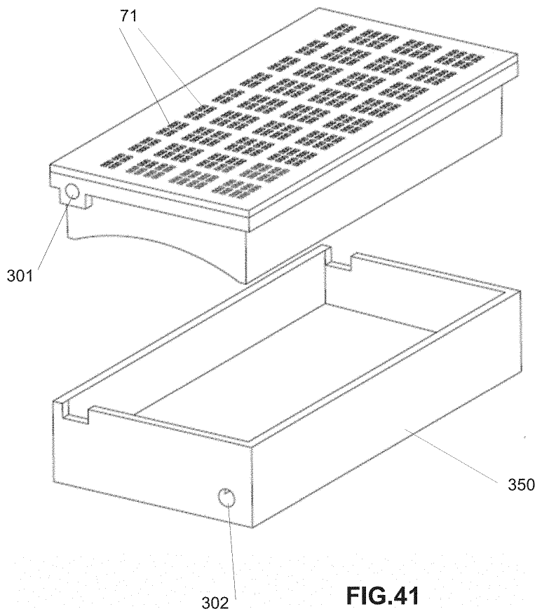

FIG. 41 shows an exploded view of the embodiment according to FIG. 35;

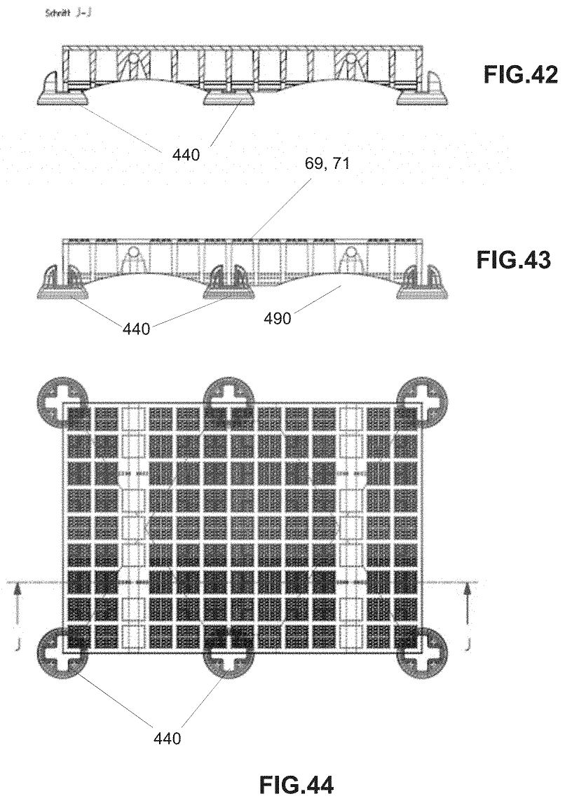

FIG. 42 shows a section J-J of a further embodiment of the floor construction element according to the invention;

FIG. 43 shows a side view of the embodiment according to FIG. 42;

FIG. 44 shows a top view of the embodiment according to FIG. 42;

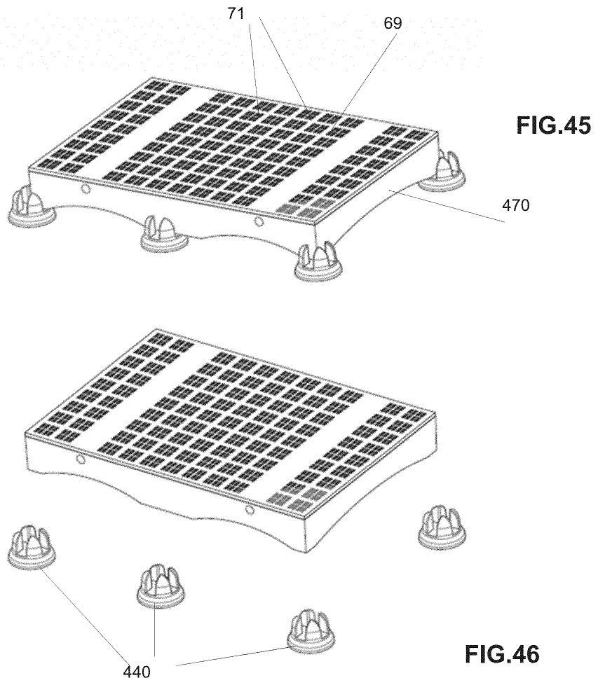

FIG. 45 shows an oblique view of the embodiment according to FIG. 42;

FIG. 46 is an exploded view of the embodiment according to FIG. 42.

FIGS. 1 to 9 show a floor construction element for a horse stable with a cover surface element 6 essentially spaced in parallel from a floor 1, on the upper side of which a bedding layer 2 (FIG. 2) is applied in the state of use, wherein a drainage cavity 4 is formed by a supporting device 170, 171 between the floor 1 and the cover surface element 6, by means of which the liquid secretions of a horse can be drained.

The support device has two lateral support walls 170, 171 spaced apart by a bottom wall 173 and on which the cover surface element 6 can be placed.

The cover surface element 6 is executed in the embodiment shown—without being limited thereto—with a square base with the dimensions 300×300 mm. By laying several cover surface elements 6 close to each other, the respective stable can be completely covered, in order to be able to apply a bedding layer to the surface created thereby. The laid cover surface elements thereby form a setting surface with evenly distributed through holes for draining the liquid excretions. Preferably, the underlying soil is on a slope or such a slope is made artificially.

The bottom wall 173 of the support device forms parallel grooves 180 for discharging the liquid excretions, wherein in the embodiment shown five parallel semi-cylindrical grooves 180 are provided which extend parallel to the two lateral support walls 170, 171. However, the design of the gutters is not essential to the invention and may vary within the scope of the invention.

The parallel grooves 180 are projecting at one end opposite the support walls 170, 171 and set back at the opposite end, so that the projecting groove sections 181 can be brought into contact with the recessed groove sections 182 of two adjacent floor construction elements and can be connected with a seal by means of sealing elements (not shown).

Furthermore, groove 175 and spring elements 176 are arranged on the outer sides of the mutually opposite support walls 170, 171, so that in each case two adjacent floor construction elements can be brought into engagement with one another on their support wall side.

In this context, it should be noted that in the description horse stables are understood to mean all facilities for housing and/or transport of horses, such as horse stables with stalls, free-range horse stables, horse trailers, horse transporters, etc. Such facilities are designed specifically for horses and take into account the specifics of horse husbandry. The bedding layer 2 has several functions, among other things, it protects against injury and also provides a base on which the horse can lie down or rest or sleep. Furthermore, the bedding layer 2 prevents splashing during urination, which in horses may cause them to stop delivering urine, which can lead to urinary retention. The floor 1 is, for example, the existing floor in a horse stall, for example, concrete, clay, screed, etc.

To prevent injury and to protect the joints of the stalled horse, the cover surface element 6 is made of an elastic material, such as a plastic, to effect a good state and the required damping effect for the horse, but at least the cover surface element 6 is formed elastically on its upper side or at least one elastic layer is present.

The cover surface element 6 thus has sufficient elastic properties in order to ensure a hoof- and joint-protecting type of accommodation. Furthermore, the cover surface element 6 also prevents horses from injuring themselves when lying down or getting up. The cover surface element 6 has a number of square passage openings 50 for draining the liquid excretions into the drainage cavity 4.

The cover surface element 6 is formed as a cover plate 60, which has at the bottom support ribs 140 and stiffening ribs 130 (FIG. 7) in the other direction, which consist of a different, harder material than the cover plate 60. However, in the manufacture of the cover surface element 6, the softer cover plate 60 and the harder support ribs 140 and stiffening ribs 130 and a surrounding frame 131 are formed in one process, so that the latter are integrally connected to the cover plate 60.

At the connecting lines of adjacent grooves 180, support surfaces 190 are formed, on which the inner support bridges 140 of the cover plate 60 rest when the cover surface element 6 is fitted.

According to the invention, the passage openings 50 are arranged in a uniformly distributed manner over the cover surface element, whereby bridges 110 (FIG. 1) extend between the passage openings 50 for support or stiffening, and the passage openings 50 are each defined by an arrangement of several screen openings 71, wherein the screen openings 71 are permeable to the liquid excretions, but prevent the entry of relatively large, solid particles into at least one drainage cavity 4 and prevent clogging of the passage openings 50 (FIG. 9).

As shown in FIG. 7, the support ribs 140 and the stiffening ribs 130 are arranged just below the ridges 110 to stiffen and support the cover plate 60. The thickness of the cover plate is about 5 mm and thins in the area with the screen openings to 2 mm, so that the screen openings are about 2 mm deep.

The arrangements of screen openings 71 forming the passage openings 50 are formed by through holes in the cover plate 60. FIG. 1 shows a detail with one of the passage openings 50, which is defined by a total of 16 screen openings 71, for example, with a diameter of 3 mm, so that a through hole of approximately 20×20 mm results, and which is separated from the adjacent passage openings by bridges 110 with a width of e.g. 8 mm. In the interior of the passage openings, additional cross-shaped stiffening bridges 210 are provided (FIGS. 1 and 9) in order to avoid being pushed in by a horse's hoof. The screen openings 71 open conically downwards to allow a better drainage of the liquid excretions. The bridges 110 and the stiffening bridges 210 serve to reinforce and should have the smallest possible width but be sufficiently wide to protect the screen openings 71 against breakage.

The passage openings 50 are arranged in a matrix-like manner, but it is also possible to make a deviating shape of the arrangement.

In order to prevent the entry of relatively large solid particles through the passage openings 50 into the drainage cavity 4 and clogging of the passage openings 50, the diameter or opening width k of the screen openings 71 is much smaller than the diameter D or the opening width of the passage openings 50, and depth t of the screen openings 71 is much smaller than the diameter D or the opening width of the passage openings 50 (FIG. 9).

A further embodiment of the invention is shown in FIGS. 10 to 15, in which the passage openings 5 are distributed uniformly over the cover surface element 64 and are separated from one another by bridges 110 (FIG. 12). In each of the passage openings 5, a screen element 7 is inserted which has a number of screen openings 70 which are permeable to the liquid excretions, but which prevent the entry of relatively large, solid particles into the drainage cavity 4 and the clogging of the passage openings 5 (FIGS. 15A to 15D).

The diameter or the opening width k of the screen openings 70 is much smaller than the diameter D or the opening width of the passage openings 5 and the thickness C of the screen 7, or the depth of the screen openings 70 is much smaller than the diameter D or the opening width of the passage openings 5 is.

The screen element 7 is formed by a hollow insert 75, which is fitted into the respective passage opening 5 of a cover plate 64, the upper end of the hollow insert 75 having a grid screen 17 and the lower end having a flange 19 (FIG. 15D). The depth t of the screen openings 71 corresponds to the thickness of the grid screen 17, which is just kept very thin for better drainage. For stiffening the very thin grid screen 17, cross-shaped reinforcing bridges 20 are formed in the interior of the hollow insert 75.

The screen elements 75 are inserted, preferably glued, into the passage openings 5 of the cover plate 64, as can be seen from FIG. 14, whereby the grid screen 17 is oriented upwards in the position of use.

The screen openings 70 open conically—in the position of use—in a downward direction to the bottom—so instead have a truncated conical shape, to better prevent clogging or shifting. The cone angle is formed in the range between 5° and 15°, preferably 10°.

The embodiments shown in FIGS. 10 to 15D have circular passage openings 5, but they may also have any other shape, for example, n-cornered, oval or slot-like, etc.

The cover plate 64 with the number of passage openings 5 extending in the thickness direction is formed from a material having a relatively high elasticity, for example made of rubber, foam, or the like.

The cover plate 64 is supported by a frame 131, which is provided with support ribs 140 and stiffening ribs 130, which form openings for discharging the liquid excretions into the drainage cavity 4.

The passage openings 5 have a circular diameter and are arranged in the form of a matrix, but could also be provided in any other form, for example square, hexagonal, etc. or in an arrangement. The diameter of the passage openings 5 may, for example, be selected from a range of 5 mm to 50 mm, but other diameters may also be formed.

In order to allow, to the extent possible, no accumulations of liquid above the cover plate 64, the passage openings 5 are arranged close to each other. In order to provide a sufficient footprint for the horse to be stalled and a corresponding strength, however, the spaces or bridges between the passage openings 5 must be kept sufficiently large.

The screen element 7 is fitted into the respective passage opening 5, so that the diameter D of the passage openings 5 is approximately equal to the outer diameter of the screen elements 7, the upper end of the insert 75 forming the grid screen 17, which is preferably formed integrally with the insert 75. The diameter or the opening width k (FIG. 15C) of the screen openings 70 of the grid screen 17 and the thickness C of the grid screen 17 are many times smaller than the diameter D of the openings 5.

### Example

D=30 mm, C=2 mm (factor F1=15 times smaller) and k=2.6 mm (factor F2=11.5 times smaller)

The factors F1, F2 are preferably in the range 10 to 30.

The thickness C of the grid screen 17 (=passage length of the screen openings 70) is much smaller than the diameter D or the opening width of the passage opening 5, whereby shifting of the grid screen 17 by debris can be avoided.

The diameter or the opening width k of the grid screen 17 is also much smaller than the diameter D or the opening width of the passage opening 5, whereby clogging of the passage openings 5 by solid components, such as bedding, etc., is prevented.

The screen element 7 is seated with its flange 19 on the underside of the cover plate 64, wherein the screen 17 of the screen element insert 75 is offset slightly downwards relative to the upper side of the cover plate 64, so that the horse's hoof cannot come into contact with the screen element 7.

The screen element inserts 75 are offset in the installed state by a distance which may, for example, be 1-2 mm in size, relative to the top of the cover plate 64. However, no offset can also be provided for.

Furthermore, the screen element 7 exhibits the reinforcing bridges 20 in the interior, which are arranged diametrically and crosswise. The screen element 7 and the reinforcing bridges 20 may be embodied, for example, by injection molding, wherein the reinforcing bridges serve for mechanical reinforcement, in order to counteract deformations that could arise due to the burden of the horse's weight.

The screen element 7 thus allows the horse urine or the horse substrate into the drainage cavity 4 and thereby prevents other main solid materials such as bedding, hay, straw or horse manure from being able to penetrate into the next lower level.

The screen element 7 can also be installed in the cover plate 64, for example, it can be vulcanized in.

Possible embodiment of the grid screen 17:
Screen grid with a mesh size or opening width k of the screen openings 70, e.g. 1 to 5 mm. Changes in the dimensions and opening widths of grid screens 17 are possible within the scope of the invention

The passage openings 5 are circular in cross-section, so hollow-cylindrical, diameter D, for example, 5 mm-50 mm arranged in a matrix, but any other geometric shape and/or arrangement of the openings 5 can be selected, as long as the drainage of the liquid horse excretions can occur without appreciable liquid accumulation from the bedding layer 1. The remaining bridges of material between the openings 5 are dimensioned so that they have sufficient strength to ensure the integrity of the cover plate 64 when loaded by the horse's legs, so that no permanent deformation or destruction can result.

The screen element 7 can be formed from a thermoplastic elastomer from the group of the TPEV or an impact-resistant polypropylene copolymer. These materials have the following mechanical properties:

Flexural modulus 1100-1400 MPa, in particular 1250 MPa

Tensile strength: 20-30 MPa, in particular 26 MPa

Impact strength: 150-180 kJ/m2

Possible embodiments of the cover plate 64:
Cut-resistant flame retardant rubber mat, 1000 mm×1500 mm (or 1000 mm×3000 mm), material thickness preferably between 6 mm to 30 mm, weight between 10 to 23.5 kg (7 kg to 16 kg/m²), natural rubber (virgin material) black or special colors
Rubber mat, 1000 mm×1500 mm, material thickness preferably between 6 mm to 30 mm, weight between 10 to 23.5 kg (7 kg to 16 kg/m²), natural rubber—new, black or special colors
Rubber mat—recycling, 1000 mm×1500 mm, material thickness preferably between 6 mm to 30 mm, weight between 8 to 19 kg (5.5 kg to 12.7 kg/m²), mainly recycled natural rubber black.

Previous bedding strata pursued the goal of an uptake of the liquid components of equine excretions that is as complete as possible, preferably by a high absorbency of the bedding material. The fully moist bedding thus needs to be changed relatively often and mixes with the solid horse excrement or horse droppings. For hygienic reasons and the resulting formation of ammonia, frequent mucking out has been required, and the excretions could be difficult to recycle.

Since the liquid excretions are separated from the solid ones via the cover plate 64 according to the invention in combination with the screen elements 7 by appropriate drainage from the bedding layer, such recovery can now be carried out much better. The horse urine can be drained and collected in tanks or manure pits, the horse droppings can be picked up and collected in a dry state, for example by means of pitchfork. For the formation of the bedding layer 2, preferably a very low-absorption material or low-absorption material execution is therefore used in the context of the invention—in contrast to conventional bedding. This contributes to the well-being of the horse as well as to the easier mucking out of the horse droppings.

Possible embodiment for the bedding layer 2:
Bedding height at least 5 cm and not more than 10 cm.
Wood granules with a diameter of 3 to 5 mm or up to 8 mm and a length of 5 mm to 10 mm or up to 30 mm, de-dusted and thermally treated.

FIGS. 16 to 21 show a further embodiment of the floor construction element according to the invention, in which the cover surface element 66 comprises a cover plate 67 and a supporting grid element 90, which is formed in the present embodiment by a step grid, e.g. GRP grid, with mutually perpendicular grating bars that form rectangular grid openings 91, which is placed on the support walls.

On the grid element 90, the cover plate 67 made of an elastic material, such as rubber, is arranged, wherein the passage openings 51 are provided in the cover plate 67, for which passage openings 51 are arranged in alignment with the grid openings 91 of the grid element 90, so that the excretions draining off through the passage openings 51 can flow through the grid openings 91 without flow obstacles.

The flat screen elements 7 with screen openings are embedded or glued into the passage openings 51 of the cover plate 67. The dimensioning of the screen openings again corresponds exactly to the principle according to the invention: The diameter or the opening width of the screen openings of the screen element 7 and the thickness of the screen element 7 are many times smaller than the diameter of the passage openings 51.

In the further embodiment of the invention according to FIGS. 22 to 27, the screen sleeves 17 are not glued to the elastic cover plate 64, but are integrally formed together with the cover plate 64, for example by injection molding.

In the further embodiment according to the invention according to FIGS. 28 to 34, the floor construction element according to the invention represents a narrow variant of the embodiment according to FIGS. 1 to 9 with only one groove 180 and one central reinforcing rib 130.

Different dimensions of prefabricated floor construction elements according to the invention can be used when installed in the stable floor, whereby the column can be covered at the edge by edge strips which are tailored as needed.

FIGS. 35 to 41 show a further embodiment of the floor construction element according to the invention with a box-shaped supporting device 350, in which a bottom wall 340 as a sloping plane and at the lowest point of the inclined plane a drain hole 302 for connection of a connecting element for the adjacent floor construction element and a purge line bore 301 is formed for connection to a purge line in the area of the highest point, by way of which the flushing water can be introduced into the interior of the floor construction element according to the invention, in order to drain the liquid excretions via the drain hole 302.

FIGS. 42 to 45 show a further embodiment of the floor construction element according to the invention, in which a support frame 470 is formed to support the cover surface element 69, through which the purge lines are conducted, and which is mounted on its underside by support legs 440 relative to the bottom 1, whereby the support frame 470 has lateral recesses 490, through which the liquid excretions can be drained away.

1. A floor construction element for a horse stable with a cover surface element and a supporting device for supporting against a floor, wherein the cover surface element has a variety of passage openings and at least one drainage cavity is formed by the supporting device between the floor and the cover surface element, through which liquid excretions of the horse can be removed, characterized in that wherein the passage openings are arranged distributed uniformly on the cover surface element, whereby bridges for supporting or stiffening extend between the passage openings, and that the passage openings each are defined by an arrangement of several screen openings that are formed in the cover surface element or a screen element is inserted into the passage openings with a number of screen openings, whereby the screen openings are permeable to the liquid excretions, but prevent the entry of relatively large, solid particles into at least one drainage cavity and prevent obstruction of the passage openings, whereby the diameter or the opening width of the screen openings is much smaller than the diameter (D) or the opening width of the passage openings and the thickness (C) of the screen element or the depth of the screen openings is much smaller than the diameter (D) or the opening width of the passage openings.

2. The floor construction element according to claim 1, wherein the passage openings are arranged in a matrix shape.

3. The floor construction element according to claim 1, wherein the cover surface element comprises a cover plate having at the bottom support in the other direction or stiffening bridges.

4. The floor construction element according to claim 3, wherein the cover plate is formed of an elastic material.

5. The floor construction element according to claim 4, wherein on the upper side of the cover plate, a damping layer is attached or a cover plate is arranged made of an elastic material.

6. The floor construction element according to claim 3, wherein the screen openings are formed in the cover plate (60).

7. The floor construction element according to claim 1, wherein the screen element is formed by a hollow insert, which is fitted into the respective passage opening, and that the upper end of the hollow insert exhibits a grid screen.

8. The floor construction element according to claim 7, wherein the hollow inserts are glued or cast into the passage openings of the cover plate.

9. The floor construction element according to claim 1, wherein the cover surface element comprises a supporting grid element and on the grid element a cover plate made of an elastic material is attached or arranged, wherein the passage openings are provided in the cover plate, which passage openings are arranged in alignment with grid openings of the grid element, and that the screen elements are embedded or glued in the passage openings of the cover plate.

10. The floor construction element according to claim 1, wherein the supporting device comprises two lateral support walls spaced apart from one another by a bottom wall, on which the cover surface element can be placed.

11. The floor construction element according to claim 10, wherein the bottom wall of the supporting device forms parallel grooves for draining the liquid excretions, and that on the connecting lines of adjacent grooves support surfaces are formed, on which the inner support bridges of the cover plate rest when the cover surface element is attached.

12. The floor construction element according to claim 10, wherein the parallel grooves opposite the support walls are formed, projecting at one end and recessed at the opposite end, so that the projecting groove sections with the recessed groove sections of two adjacent floor construction elements can be brought into contact with the front side and connected with a seal by means of a sealing element.

13. The floor construction element according to claim 10, wherein groove and spring elements are arranged on the outer sides of the mutually opposite support walls, so that in each case two adjacent floor construction elements can be engaged with one another on their support wall side.

14. The floor construction element according to claim 10, wherein the bottom wall is formed as a sloping plane and a drain hole is formed at the lowest point of the inclined plane and a flushing bore for connection to a flushing line in the area of the highest point.

15. The floor construction according to claim 1, wherein a support frame is formed for supporting the cover surface element, through which the flushing lines are passed, and which is mounted on its underside by support feet relative to the floor (1), wherein the support frame has recesses through which the liquid excretions can be drained away.
